(19) United States
(12) Patent Application Publication
(10) Pub. No.: US 2013/0021087 A1
(43) Pub. Date: Jan. 24, 2013

(54) INPUT DEVICE WITH ELASTIC MEMBRANE

(71) Applicants: Samuel Rosset, Chaumont (CH); Christoph Romer, Zurich (CH); Damian Maria Schneider, Winterthur (CH); David A.R. Niederer, Kuttigen (CH); Manuel Aschwanden, Allenwinden (CH)

(72) Inventors: Samuel Rosset, Chaumont (CH); Christoph Romer, Zurich (CH); Damian Maria Schneider, Winterthur (CH); David A.R. Niederer, Kuttigen (CH); Manuel Aschwanden, Allenwinden (CH)

(73) Assignee: OPTOTUNE AG, Dietikon (CH)

(21) Appl. No.: 13/577,769

(22) PCT Filed: Feb. 2, 2011
(86) PCT No.: PCT/CH2011/000014

§ 371 Date: Oct. 10, 2012

(30) Foreign Application Priority Data
Feb. 8, 2010 (CH) PCT/CH2010/000036

(51) Int. Cl. G01N 27/04; H01H 11/00; H01H 1/10

(52) U.S. Cl. 327/509; 200/517; 29/622

(57) ABSTRACT

A device includes a flexible polymer membrane with compliant electrodes attached thereto. The membrane is suspended in a frame. A handle, which is displaceable in respect to the frame, is connected to the membrane. A displacement of the handle causes the electrodes on the membrane to be deformed, thereby changing their area and resistance. The change of area or resistance is measured by a capacitive or resistive sensing circuit and is used to measure the deformation and therefore the displacement of the handle.

### FIELD OF THE INVENTION

The invention relates to an input device having an elastic membrane as well as to a use of said input device and a method for its manufacture. Such an input device can in particular be used as a joystick and/or in gaming applications.

### BACKGROUND OF THE INVENTION

Input devices for converting mechanical displacements into electrical signals must meet restrictive cost and space requirements for applications such as mobile telephones, smartphones and other portable electronics.

Various types of input devices have been developed as conventional pointing devices. These coordinate input mechanisms include: a plurality of electromagnetic conversion devices that rely on the change of, among others, electrical resistance, electrical capacitance, magnetic flux and temperature. Other devices employ optical detection systems. However, any of those types of mechanisms are typically made of numerous parts which add to complexity, cost and size.

U.S. Pat. No. 5,689,285 employs a pressure-sensitive resistive membrane, placed between two conductors. The annular direction and force of contact is determined through the change in resistance measured through the membrane.

US 2003/0151103 employs a ring-shaped resistive membrane. When the user presses on the button, the electrical circuit is closed and the electrical resistance is indicative of the direction of the pressure.

U.S. Pat. No. 6,344,791 employs a deformable resistive membrane. Upon pressure, the circuit is closed and the electrical resistance determines the position of the pointer.

FR 2933605 discloses an input device for paraplegic patients relying on strain gauges to measure the position of a handle which is connected to a membrane. These strain gauges measure the forces that result from deformations in the membrane when the handle is displaced in different directions.

### OBJECT AND SUMMARY OF THE INVENTION

It is an object of the invention to propose an improved mechanical input device, in particular a joystick.

This object is achieved by the device of claim 1. Accordingly, the device comprises

a frame,

a flexible polymer membrane held in the frame,

a compliant sensing electrode arranged on or in said membrane, and

a handle mounted to said frame and connected to said membrane.

The handle is displaceable at least along a first direction parallel to the membrane, wherein a displacement of the handle in said first direction causes a deformation of said sensing electrode.

The device is configured such that, when the handle is moved in the first direction, the polymer membrane is deformed. As a consequence, the resistance and/or area of the sensing electrode(s) changes. This change can be measured and converted into an electrical signal, which can e.g. be used as an input signal for controlling the motion of a pointer or a figure on a screen.

In one advantageous embodiment, the device comprises a resistance sensing circuit connected to the sensing electrode for measuring the resistance of the same and for thereby generating a signal or value indicative of the handle position. Typically, the resistance increases when the section of the membrane containing the sensing electrode is distended.

In another advantageous embodiment, the device comprises at least a top and a bottom sensing electrode arranged on opposite sides of the membrane as well as a capacitance sensing circuit connected to said top and bottom sensing electrodes. The capacitance sensing circuit measures the capacitance between the two sensing electrodes and thus generates a signal or value indicative of the handle position. Typically, the capacitance increases when the section of the membrane containing the sensing electrodes is distended because the area of the sensing electrodes increases and their distance decreases.

Advantageously, when the handle is released, i.e. in the absence of an external force applied to the handle, the membrane moves the handle to a zero position. Upon application of the external force, the handle is displaced from the zero position against a resetting force generated by the membrane. In other words, the handle is self-centered by the restoring force of the polymer membrane.

Advantageously, the restoring force of the polymer membrane can be augmented by an additional spring element which is arranged between the handle and the polymer membrane. In addition to supplementing the restoring force, the spring element can aid in hampering unwanted rotational movements of the handle and the connected membrane around an axis which is perpendicular to the surface of the polymer membrane.

Advantageously, even when the handle is in its zero position, the membrane is elastically extended, in particular along the first direction. Thus, when the handle is moved along the first direction, the membrane remains taught everywhere, and buckling is avoided. Advantageously, the extension is by at least 100% in length.

In another advantageous embodiment, the handle is displaceable in a third direction perpendicular to the membrane. In order to detect such a displacement, the device further comprises:

a first contact electrode mounted to the membrane,

a second contact electrode mounted to the frame, and

a gap between said first and second contact electrodes.

A sufficient displacement of said handle along said third direction elastically deforms the membrane for closing said gap. Hence, when the handle is pushed down in the third direction, the contact electrodes touch each other, resulting in a measurable resistance change. This resistance change can be interpreted as a selection action.

In another advantageous embodiment, the device comprises at least a top and a bottom elastic actuating electrode arranged on opposite sides of the membrane as well as an AC voltage generator connected to the actuating electrodes for applying an AC voltage over the actuating electrodes. The actuating electrodes can be the same electrodes as the sensing electrodes, or separate electrodes. When the AC voltage is applied between the actuating electrodes, electrostatic forces cause a reduction of the distance between them. This results in deformation of the membrane and thereby in a lateral displacement of the handle attached to the membrane. This displacement can be sensed by the operator touching the handle, as a feedback signal. Since the planar elongation of the polymer membrane depends on the voltage difference applied between the electrodes, the displacement of the handle can easily be controlled.

An alternative advantageous approach to generate such a feedback signal to the operator is to integrate one or more layers of an electroactive polymer (EAP) with top and bottom electrodes in the head section of the handle, which can consist of two or more parts. This layer of electroactive polymer can either be arranged similarly to a “classical capacitor” actuator in which the layer of EAP is sandwiched between a top- and a bottom electrode, or as zipper actuator with at least partly inclined surfaces and spatially varying electrode distances in the head section of the handle. Upon application of a voltage between the electrodes, the distance between these electrodes typically decreases, thus leading to a reduction in length along the third direction of the head section of the handle and thus providing a feedback vibration to the operator.

The device can thus be used as input device for motion control and feedback device at the same time.

In another advantageous embodiment, the geometries and positions of the sensing electrodes on or in the membrane are arranged such that a simple yet highly sensitive readout procedure can be used to determine the position of the handle. In this embodiment, two basically line-shaped electrode legs extend essentially straight from the periphery of the membrane to its center part where they are connected to each other, thus forming a letter V-shaped electrode. At least two of these letter V-shaped electrodes are arranged on or in the membrane at a mutual angle of rotation of typically 90°, with the axis of rotation being perpendicular to the membrane surface. If the handle is displaced in a direction parallel to the membrane which corresponds to the axis of symmetry of one of these letter V-shaped electrodes, the resistance of the corresponding electrode changes considerably while the resistance of the perpendicular electrode remains essentially constant. Thus, a decoupling of the electrical position readout signals is achieved and the position of the handle can be detected with high sensitivity and low computational effort. An optional third letter V-shaped electrode enables the readout of rotational movements of the handle.

Advantageously, the polymer membrane has a thickness larger than 100 nm and/or smaller than 5 mm. A thickness below 100 nm makes the device difficult to manufacture, while a thickness above 5 mm requires a large voltage to be applied to the electrodes for the feedback function and a large force external mechanical displacement.

In an advantageous embodiment, the polymer membrane is made of polymers (e.g. PDMS Sylgard 186 by Dow Corning or Optical Gel OG-1001 by Litway) or acrylic dielectric elastomers. Such materials allow a substantial deformation so that the handle can be displaced by a large distance.

An embodiment of a device according to the present invention may be obtained by a procedure comprising the following steps:

applying the electrode(s) to the polymer membrane, e.g. by printing,

stretching a polymer film, advantageously by at least 20%, e.g. 100%, in x- and y-direction

attaching the membrane to said frame; and

applying said handle to the membrane.

The order of the above steps is advantageously as indicated, but it may also be changed. For example, the electrode(s) may be applied after stretching the membrane or after applying the membrane to the frame. However, advantageously, the electrodes should be stretched together with the membrane, i.e. the electrodes should be applied to the polymer film prior to stretching the same.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a sectional view of a first embodiment of a device using resistive measurements,

FIG. 2 shows the device of FIG. 1 with the handle moved to one side along direction X,

FIG. 3 shows the device of FIG. 1 with the handle moved to the opposite side of direction X,

FIG. 4 is a top view of the device of FIG. 1,

FIG. 5 is the device of FIG. 4 with its handle displaced along Y

FIG. 6 is the device of FIG. 4 with its handle displaced opposite to Y,

FIG. 7 is a second embodiment of the device using capacitive measurement,

FIG. 8 is a top view of the device of FIG. 7,

FIG. 9 is a sectional view of a third embodiment having a limiter for vertical displacement,

FIG. 10 is a sectional view of a fourth embodiment having a limiter for vertical displacement,

FIG. 11 is a sectional view of a fifth embodiment designed to detect a vertical handle motion,

FIG. 12 is the device of FIG. 11 with depressed handle,

FIG. 13 is a top view of the device of FIG. 11,

FIG. 14 is a sectional view of a sixth embodiment designed to detect a vertical handle motion,

FIG. 15 is the device of FIG. 14 with depressed handle,

FIG. 16 is a sectional view of a seventh embodiment designed to detect a vertical handle motion,

FIG. 17 is a sectional view of an eighth embodiment of the device with mechanical feedback,

FIG. 18 is a top view of the device of FIG. 17,

FIG. 19 illustrates the position of the handle without applied voltage,

FIG. 20 illustrates the position of the handle with applied voltage,

FIG. 21 is a top view of a ninth embodiment having a reference electrode,

FIG. 22 is a top view of a tenth embodiment of the device having a single electrode,

FIG. 23 is a top view of the device of FIG. 22,

FIG. 24 is a variant of the device of FIG. 23,

FIG. 25 is an eleventh embodiment of the device with rotating handle,

FIG. 26 is a top view of the device of FIG. 25 with the handle in a first rotary position,

FIG. 27 is a top view of the device of FIG. 25 with the handle in a second rotary position,

FIG. 28 is an embodiment of a resistance sensing circuit to be used in the present device,

FIG. 29 is an embodiment of a capacitance sensing circuit to be used in the present device,

FIG. 30 is a top view of a thirteenth embodiment of the device using resistive measurements with letter V-shaped electrodes,

FIG. 31 is the device of FIG. 30 with its handle displaced along Y,

FIG. 32 is the device of FIG. 30 with its handle displaced opposite to Y,

FIG. 33 is a fourteenth embodiment of the device with a two-part head section of the handle and an electroactive polymer and two electrodes in the head section,

FIG. 34 is the head section of the handle of FIG. 33 with the top part of the head section retracted opposite to Z,

FIG. 35 is a variant of the head section of the handle of FIG. 33 with a zipper actuator,

FIG. 36 is the head section of the handle of FIG. 35 with the head section retracted opposite to Z,

FIG. 37 is a perspective representation of a fifteenth embodiment of the device comprising a spring element, and

FIG. 38 is a top view of a variant of the device of FIG. 23 utilizing a single electrode.

Any top views represent the frame, membrane and handle in semi-transparent manner and show the bottom electrodes of the membrane only, with the exception of the top views of FIGS. 26 and 27, which show the top electrodes only.

### DETAILED DESCRIPTION OF EMBODIMENTS

### Definitions

The term “flexible polymer membrane” designates a flexible material body that has a thickness much smaller than its width and length, and that can be reversibly and elastically extended, along a direction perpendicular to its width, by at least 10% without being damaged.

The term “rigid” is used to describe a material that is substantially more rigid than the flexible polymer membrane.

The term “parallel to the membrane” is defined as follows:
if the membrane lies within a single plane, the term designates a direction parallel to said plane;
if the membrane does not lie within a single plane, the term designates a direction parallel to a local tangential plane of the membrane at a location where the handle is connected to the membrane.

The terms “axial” and “perpendicular to the membrane” designate a direction perpendicular to all directions that are parallel to the membrane.

The term “lateral” is used to designate a direction perpendicular to the axial direction, i.e. a direction parallel to the membrane.

The term “flexible electrode” or, equivalently, “compliant electrode” for an electrode on or in the membrane designates an electrode that can be reversibly and elastically extended together with the membrane by at least 20% without being damaged.

“Top” and “bottom” designate a direction where the apex of the handle is directed towards the top of the device and the membrane is below the handle. Any terms relating to a vertical reference system, such as “up”, “down”, “above”, “below” etc. are to be interpreted in this sense.

### Introduction

The embodiments shown in the following exploit one or both of the following effects:

1. Position measurements are carried out using the fact that stretching a compliant electrode on a membrane changes its area and resistance. The change in resistance can be measured by means of a resistance sensing circuit. The change in area can be measured using a capacitance sensing circuit.

2. Force feedback is provided using displacements due to Maxwell stress induced deformation. This phenomenon relates to the deformation of a polymer material sandwiched between two compliant electrodes. When a voltage is applied between said electrodes, the electrostatic forces resulting from the free charges squeeze and stretch the polymer.

The present invention can be implemented in a variety of forms, e.g. as joystick. In the following, we describe some of these applications and various embodiments of the device.

### First Embodiment

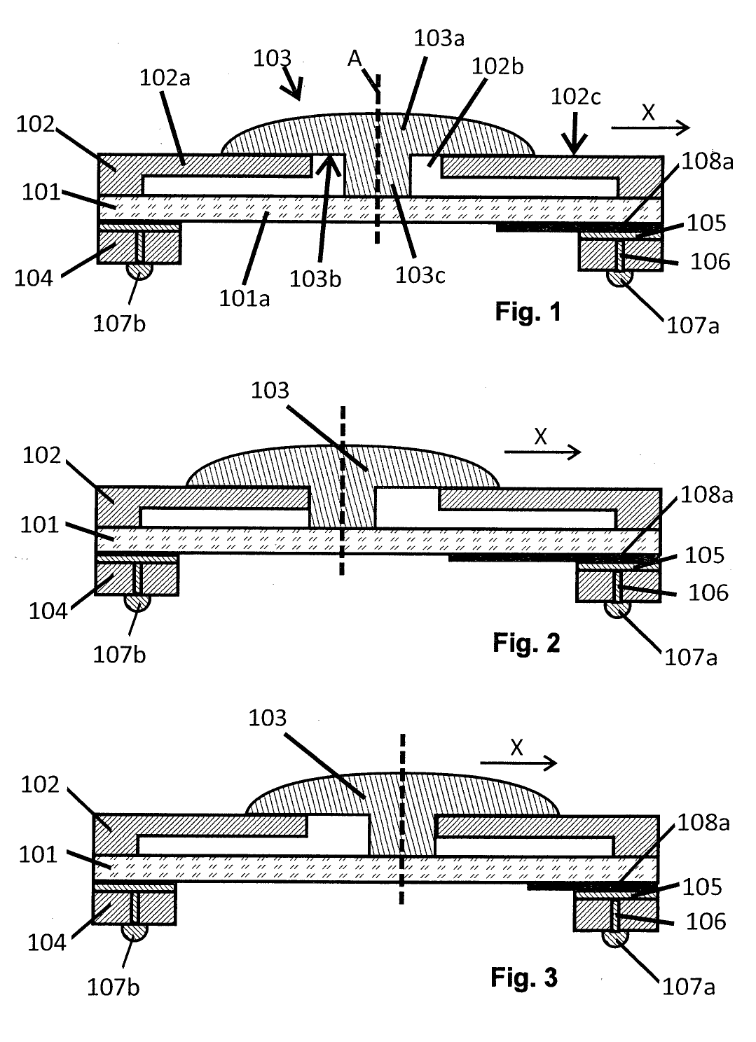

One possible embodiment of the present invention is a self-centering joystick as shown in FIGS. 1-6. This embodiment comprises a polymer membrane 101 held in a rigid frame 102. In the embodiment shown, membrane 101 and frame 102 are rotationally symmetric about an axis A extending perpendicularly to membrane 101. A handle 103 is mounted in frame 102 and connected to membrane 101.

Frame 102 forms an upper lid 102a extending parallel to membrane 101 and having a central opening 102b. The top side (i.e. the side facing away from membrane 101) of lid 102a forms a flat support surface 102c.

Handle 103 can e.g. directly form a button operated by a user, or it may be connected to a rod or stick for easier manipulation. It has a head section 103a with a flat bottom or sliding surface 103b resting against support surface 102c. A shaft section 103c of handle 103 extends from head section 103b through opening 102b and is anchored in membrane 101, e.g. by welding or gluing.

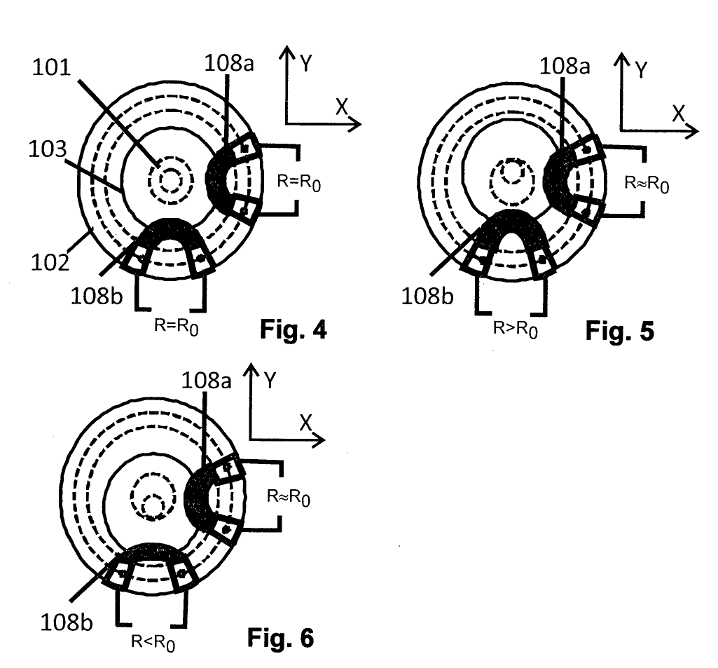

Handle 103 is of a rigid material and displaceable along a first direction X parallel to membrane 101 as well as a second direction Y parallel to membrane 101 and perpendicular to first direction X (see FIG. 4). In fact, in the present embodiment, handle 103 is displaceable in any direction within the plane spanned by X and Y, with sliding surface 103b sliding against support surface 102c. It must be noted, though, that the principles of the present invention can also be used for a device whose handle is displaceable in a single direction only.

Membrane 101 comprises a section 101a, which is suspended within frame 102, with handle 103 being connected to the suspended section 101a. Membrane 101 is suspended in frame 102 in elastically extended state such that it remains stretched for any position of handle 103.

Sensing electrodes 108a and 108b are applied to the surface of or embedded within membrane 101. The electrodes are arranged at least partially in or on suspended section 101 a of membrane 101. The geometries of the electrodes can be round, square, lines or any other appropriate form. In the first embodiment, they are substantially U-shaped with a middle section extending into suspended section 101 a of membrane 101 and end sections being connected to metal pads 105. The metal pads 105 are arranged at the top side of a foot section 104 of frame 102. Vias 106 extend from the metal pads 105 to flip-chip contacts 107a at the bottom of foot section 104. Further flip-chip contacts 107b may be provided at the bottom of foot section 104 for mounting purposes or for contacting other parts of the device, as will be illustrated in later examples.

Without the application of an external force, membrane 101 will assume its minimum energy state as shown in FIGS. 1, 4, and 30, where handle 103 is in the centre of the device, in its “zero position”. When an external force in the X-Y-plane is applied to handle 103, handle 103 is displaced from its zero position against a resetting force of membrane 101. This will cause membrane 101 to be deformed, thereby either stretching or compressing the sensing electrodes 108a, 108b. In FIGS. 5 and 6, this is illustrated for a displacement along the direction Y, where electrode 108b is either stretched (FIG. 5) or compressed (FIG. 6). Similarly, FIGS. 2 and 3 illustrate a displacement of along and opposite to direction X.

The compression or extension of a sensing electrode 108a, 108b causes its resistance to change. This change can be measured by means of a resistance sensing circuit. Such a circuit, which can be used with any of the embodiments shown herein, is illustrated in FIG. 28, where the electrode 108a or 108b to be sensed is shown as unknown resistor Rx. Resistor Rx is in series to a reference resistor Rref in a voltage divider, and the two resistors are arranged between ground and a DC reference voltage. Reference resistor Rref can be a conventional, fixed resistor, or it may be formed by a reference electrode on membrane 101, as further described below.

The voltage between the two resistors in respect to ground is processed as a measure of the position of handle 103, e.g. by amplification in an amplifier 140 and analog-to-digital conversion in an ADC 141.

It will be understood that the resistance sensing circuit of FIG. 28 is but one of numerous circuits that can be used for deriving a digital or analog signal indicative of the resistance of the sensing electrodes.

In the embodiment of FIGS. 1-6, lid 102a forms a limiter, subsequently called the “first limiter”, restricting the displacement of handle 103a along directions X and or Y. Upon a maximum displacement of handle 103 along X or Y, as shown in FIGS. 2 and 3, shaft section 103c abuts against lid 102a, thereby preventing further displacement. It must be noted that when the handle is lifted up, and four sensing electrodes are equally distributed on the membrane, the device can also be used to measure axial displacement. In this case, the resistance of all four sensing electrodes is increasing, due to the simultaneous elongation of the electrodes.

### Second Embodiment

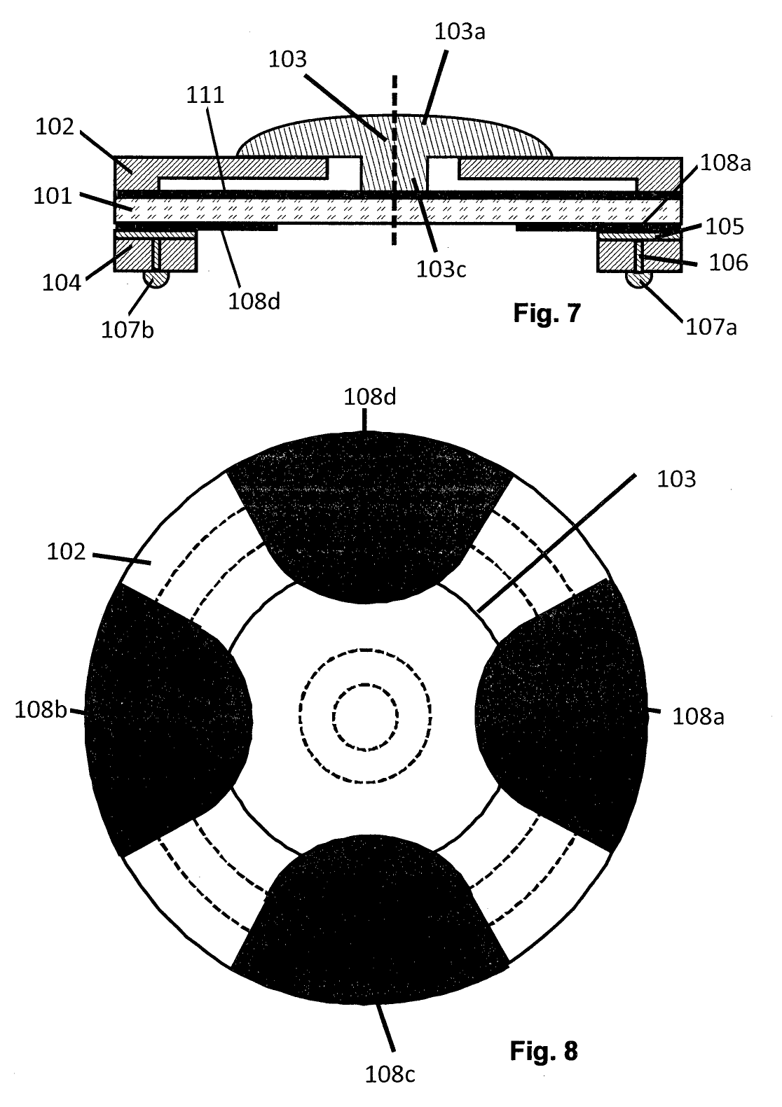

The second embodiment of the device shown in FIGS. 7 and 8 substantially corresponds to the first embodiment, with the exception that it is designed to use a capacitive measurement for determining the position of handle 103.

For this purpose, membrane 101 is equipped with at least one top electrode 111 and at least one bottom electrode 108a-108d, both of which are acting as sensing electrodes. The top and bottom electrodes are arranged on opposite sides of the membrane, and their mutual electrical capacitance depends on their size and distance. As mentioned above, both size and distance change when membrane 101 is stretched or compressed due to a movement of handle 103, i.e. the capacitance is a measure of the position of handle 103.

As can be seen in FIG. 8, which illustrates the positions of the bottom electrodes 108a-108d, there are four such electrodes arranged at the periphery of the four quadrants of membrane 101. At least two bottom electrodes (or, more generally, at least two capacitors formed by the sensing electrodes) are required if handle 103 has two degrees of freedom, and at least one bottom electrode or capacitor is required if handle 103 has one degree of freedom. Providing two bottom electrodes or capacitors per degree of freedom allows to provide more accurate measurements, e.g. by differentially processing their capacitances.

In the embodiment of FIG. 7, top electrode 111 is a single electrode covering the whole membrane 101. Such a simple electrode is easy to manufacture and provides electrical shielding for the components below it. Alternatively, top electrode 111 can consist of several separate segments, with each segment e.g. coinciding with a single bottom electrode 108a-d.

A capacitance sensing circuit is connected to the device for measuring the capacitance Cx formed by a top and a bottom electrode. An embodiment for such a circuit is shown in FIG. 29. Similar to the circuit of FIG. 28, capacitor Cx is in series to a reference capacitor Cref in a voltage divider, and the two capacitors are arranged between ground and an AC reference voltage Vref. Reference capacitor Cref can be a conventional, fixed capacitor, or it may be formed by a reference capacitor on membrane 101. In particular, in the embodiment of FIG. 8, it may be the capacitor formed by the sensing electrodes diagonally opposite to the sensing electrodes forming capacitor Cx. For example, if capacitor Cx is formed by bottom electrode 108a and top electrode 111, capacitor Cref may be formed by bottom electrode 108b and top electrode 111. This design has the advantage that temperature and material drift effects affect both Cx and Cref in similar manner, while a displacement of handle 103 affects Cx and Cref in opposite manner, thereby maximizing the signal to drift/noise ratio.

In the circuit of FIG. 29, the voltage over capacitor Cx is processed as a measure of the position of handle 103, e.g. by amplification in an amplifier 140, low pass filtering in a low pass filter 142 and analog-to-digital conversion in a ADC 141.

### Third Embodiment

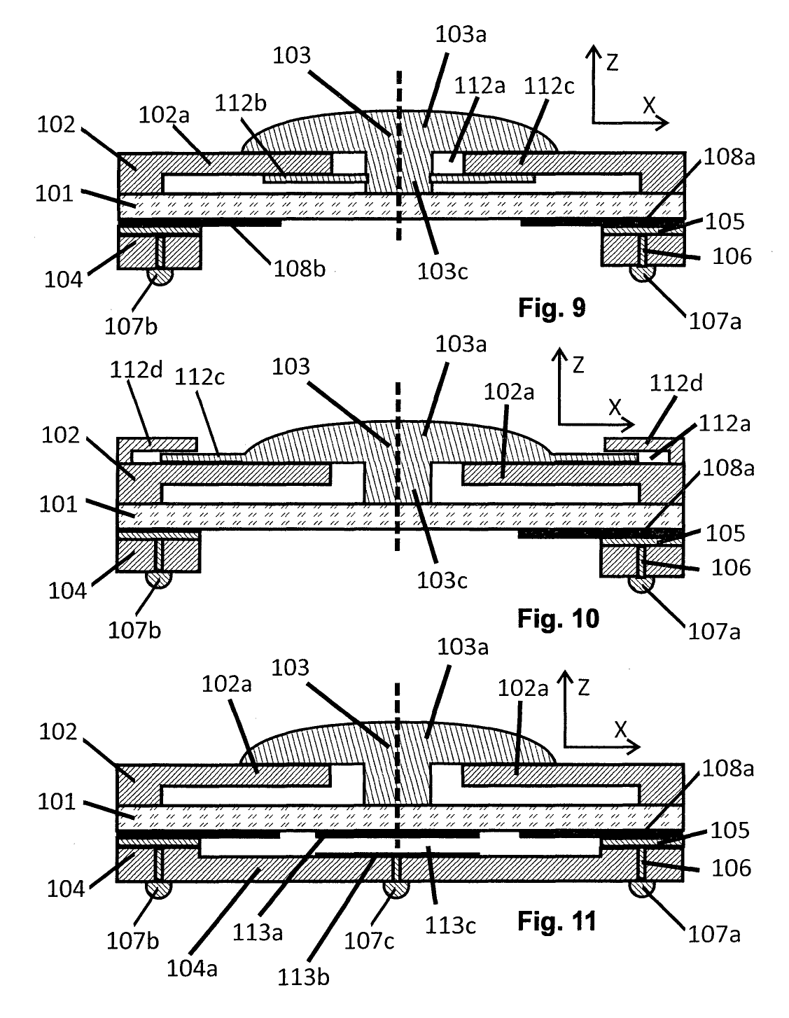

The third embodiment, shown in FIG. 9, substantially corresponds to the first embodiment of FIGS. 1-6, but it comprises a limiter, in the following called the “second limiter”, preventing a displacement of handle 103 into a third direction Z perpendicular to membrane 101.

In the embodiment of FIG. 9, the second limiter comprises
A slot 112a formed on handle 103 between the bottom side of head section 103a and a rigid plate 112b. Rigid plate 112b is mounted to shaft section 103c and extends parallel to membrane 101,
A projection 112c formed on frame 102, extending parallel to membrane 101 and reaching into recess 112a. Projection 112c is formed by lid 102a of frame 102.

Slot 112a and projection 112c interlock in direction Z, thereby preventing a movement of handle 103 along direction Z, while allowing for a movement of handle 103 in directions X and/or Y.

### Fourth Embodiment

The fourth embodiment, shown in FIG. 10, substantially corresponds to the third embodiment of FIG. 9, but has a slightly modified design of the second limiter. In this embodiment, the second limiter comprises:
A slot 112a formed on frame 102 between lid 102a and a bracket plate 112d. Bracket plate 112d is mounted to the top of lid 102a and comprises a section extending parallel to membrane 101.
A projection 112c formed on handle 103, extending parallel to membrane 101 and reaching into recess 112a. Projection 112c is formed by a plate mounted to the periphery of head section 103a of handle 103.

Again, slot 112a and projection 112c interlock in direction Z, thereby preventing a movement of handle 103 along direction Z, while allowing for a movement of handle 103 in directions X and/or Y.

### Fifth Embodiment

The fifth embodiment is shown in FIGS. 11-13. In this embodiment, handle 103 is displaceable along third direction Z.

Advantageously, a displacement of handle 103 occurs under elastic deformation of a spring member, thus that handle 103 can be pressed down under deformation of the spring member and returns to its original position when the pressure is released.

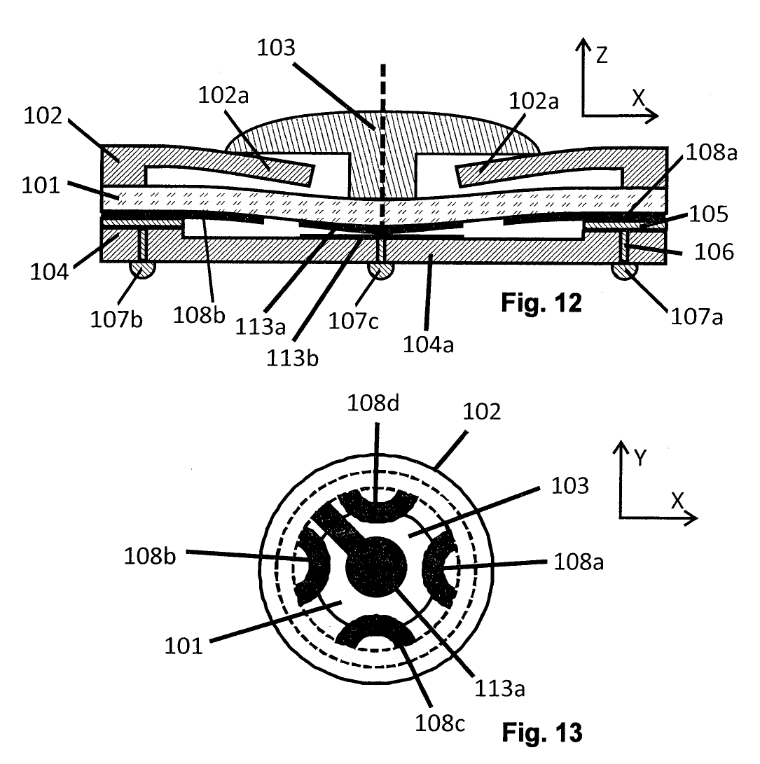

In the embodiment of FIGS. 11-13, the spring member is formed by lid 102a of frame 102, which bends downwards, as shown in FIG. 12, when handle 103 is pushed down.

To detect a depression of handle 103, a first contact electrode 113a is mounted to the bottom side of membrane 101 and a second contact electrode 113b is mounted to the top side of a bottom section 104a of frame 102. In the relaxed state of the device (i.e. when handle 103 is not pushed down), the first and second contact electrodes 113a, 113b are at a distance from each other, i.e. a gap 113c is formed between them (see FIG. 11). Upon sufficient displacement of handle 103 along direction Z, membrane 101 is deformed such that gap 113c is narrowed and ultimately closed when the contact electrodes 113a, 113b come into contact with each other. Hence by measuring the capacitance Cx between the electrodes 113a and 113b, a depression of handle 103 can be detected and quantified. Additionally, by applying a voltage over the contact electrodes 113a, 113b and monitoring the current, the closing of the gap 113c can be detected. In the same manner, it can be detected if (and how far) the user lifts handle 103 because gap 113c expands and the capacitance Cx between the electrodes 113a, 113b decreases. Alternatively, electrode 113b can be a dome switch, providing an improved clicking feedback to the user.

### Sixth Embodiment

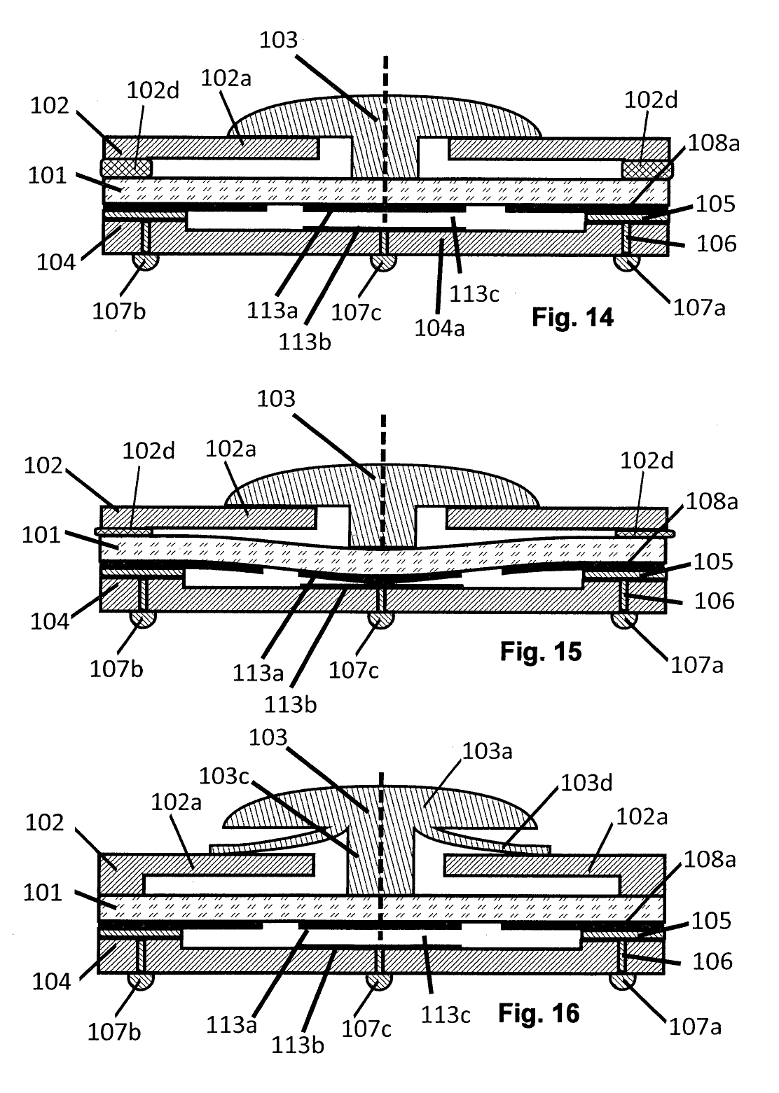

The sixth embodiment, shown in FIGS. 14 and 15, corresponds to the fifth embodiment of FIGS. 11-13, with a different design of the spring member that is deformed when pressing down handle 103. In this embodiment, the spring member is formed by a rubber elastic element 102d arranged between lid 102a of frame 102 and membrane 101. When pressing handle 103 down, rubber elastic element 102d of frame 102 is compressed, as shown in FIG. 15. When handle 103 is released, rubber elastic element 102d expands and returns to the position as shown in FIG. 14.

Again, when pressing handle 103 down, gap 113c is closed and the contact electrodes 113a, 113b touch.

### Seventh Embodiment

The seventh embodiment, shown in FIG. 16, corresponds to the fifth embodiment of FIGS. 11-13, again with a different design of the spring member that is deformed when pressing down handle 103. In this embodiment, the spring member is formed by an elastic collar 103d of handle 103. Elastic collar 103d is arranged below head section 103a of handle 103 around shaft section 103c. At its radially inner end, it is connected to head section 103a or shaft section 103c, while its radially outer end is elastically displaceable along direction Z and rests against lid 102a of frame 102. When handle 103 is pushed down, elastic collar 103d is deformed thus that gap 113c can be closed. When handle 103 is released, elastic collar 103d returns to its configuration shown in FIG. 16.

### Eighth Embodiment

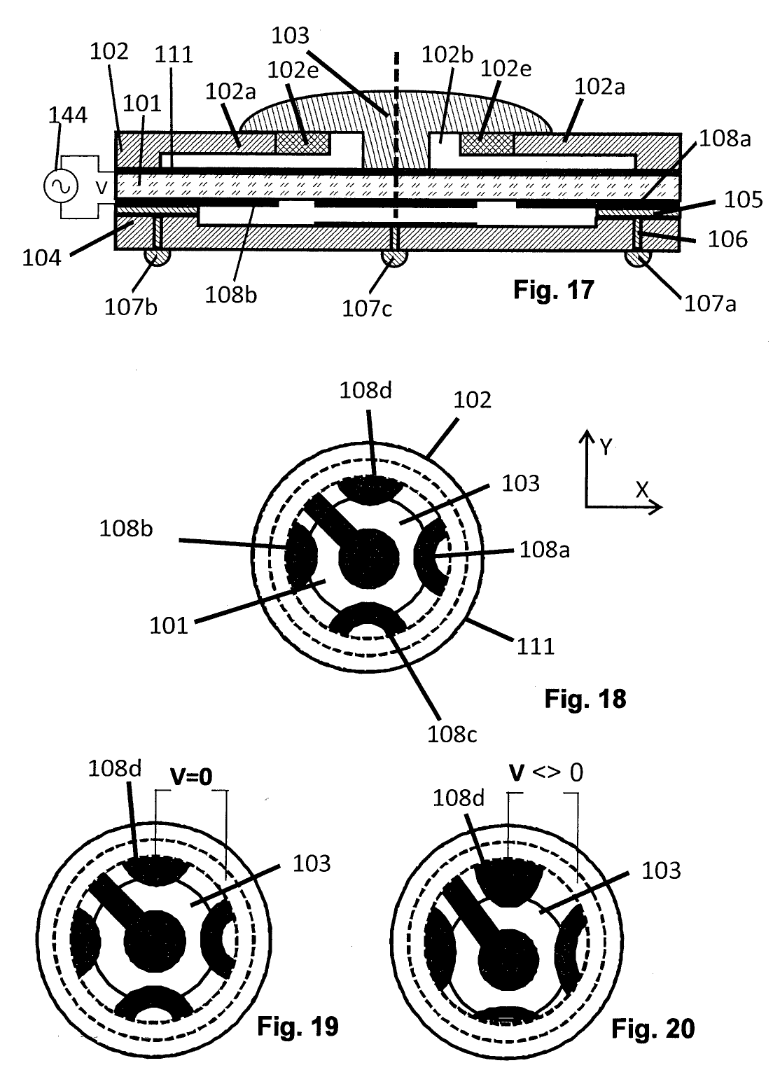

The eighth embodiment, shown in FIGS. 17-20, substantially corresponds to the fifth embodiment of FIGS. 11-13, with two exceptions:
an elastic limiter section is provided for elastically restricting a motion of handle 103 along directions X and/or Y and
it is adapted to provide sensory feedback to the user.

As mentioned in context with the first embodiment, lid 102a forms a “first limiter” for restricting the displacement of handle 103 along directions X and/or Y. In the embodiment of FIGS. 17-20, the first limiter is not formed by lid 102a itself, but by an elastic limiter section 102e, which is of a softer material than lid 102a and frame 102, thereby cushioning the limiter effect on handle 103. Advantageously, and as shown in FIG. 17, elastic limiter section 102e extends annularly around opening 102b.

For providing sensory feedback to the user, at least one top actuating electrode 111 is applied to the top side of membrane 101, and at least one bottom actuating electrode 108b, 108d is applied to the bottom side of membrane 101.

Furthermore, the device comprises an AC and/or DC voltage generator 144 connected to the top and bottom actuating electrodes in order to apply an voltage across them. The effect of actuating such a voltage is illustrated in FIGS. 19 and 20. When no voltage is applied, as shown in FIG. 19, membrane 101 is undeformed and handle 103 rests in the center of the device. When a non-zero voltage is applied, e.g. between bottom electrode 108d and top electrode 111, as shown FIG. 20, membrane 101 between them is compressed, which causes it to laterally expand, thereby moving handle 103 away from the center of the device.

Hence, the application of an AC voltage to the actuating electrodes causes handle 103 to vibrate.

Voltage generator 144 can generate a continuously varying voltage, individual voltage pulses or any other voltage shape including DC voltage.

### Ninth Embodiment

As mentioned in respect to the first embodiment and to FIG. 28 above, the resistance of the sensing electrodes (if a resistive measurement is used) is advantageously measured in respect to a reference resistor Rref.

Since the resistance of the sensing electrodes depends, to some degree, on temperature, other environmental parameters (such as humidity) or aging effects, it is desirable if the reference resistor Rref is itself formed by an electrode arranged on membrane 108e.

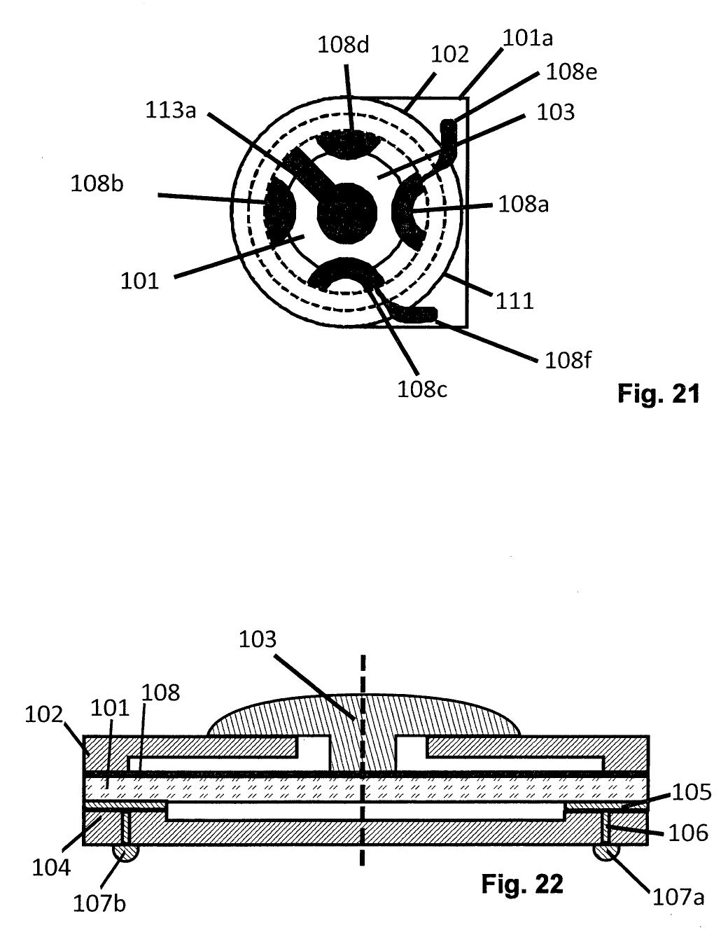

An embodiment of such a device is shown in FIG. 21, where membrane 101 comprises an extended section 101 a extending beyond the clamp formed by frame 102, thus that extended section 101a is not deformed when moving handle 103. A reference electrode 108e is arranged on extended section 101a. It is advantageously made in the same manufacturing step as the sensing electrodes 108a, 108c and is therefore of the same material and has the same thickness.

The input voltage U to amplifier 140 of the circuit of FIG. 28 is given by

U=Vref/((Rref/Rx)+1)

Hence, the circuit of FIG. 28 generates a signal depending on the ratio between Rref and Rx. In other words, the resistance sensing circuit measures the resistance Rx of the sensing electrode in respect to the resistance Rref of the reference electrode, and any effect that affects both resistances in the (proportionally) same manner does not have any influence on the output of the resistance sensing circuit.

In the embodiment of FIG. 21, the reference electrode 108e is arranged in a section of membrane 101 that does not deform when handle 103 is displaced. Alternatively, the reference electrode may also be on the part of membrane 101 that deforms upon a displacement of handle 103, as long as it deforms differently from the sensing electrode. In particular, when using an electrode design as shown in FIG. 13, two electrodes opposite each other can be used as reference resistance Rref and sensing resistance Rx. For example, electrode 108a can be used as sensing resistance Rx and electrode 108b can be used as reference resistance Rref. Since a displacement of handle 103 along X changes the resistances of the electrodes 108a, 108b in opposite directions, an even higher sensitivity results than with the design of FIG. 21. On the other hand, when displacing handle 103 along Y, the electrodes 108a, 108b vary in the same manner, and therefore no change of signal is observed at the output of amplifier 140.

In more general terms, the device advantageously comprises
a first electrode section (such as sensing electrode 108a of FIG. 21 or 13) and a second electrode section (such as electrode 108e of FIG. 21 or 108b of FIG. 13) arranged at different regions on or in the membrane, and
a sensing circuit (such as the circuit of FIG. 28) adapted to measure a parameter (such as voltage U above) depending on a ratio of the resistances of the first and said second electrode sections.

### Tenth Embodiment

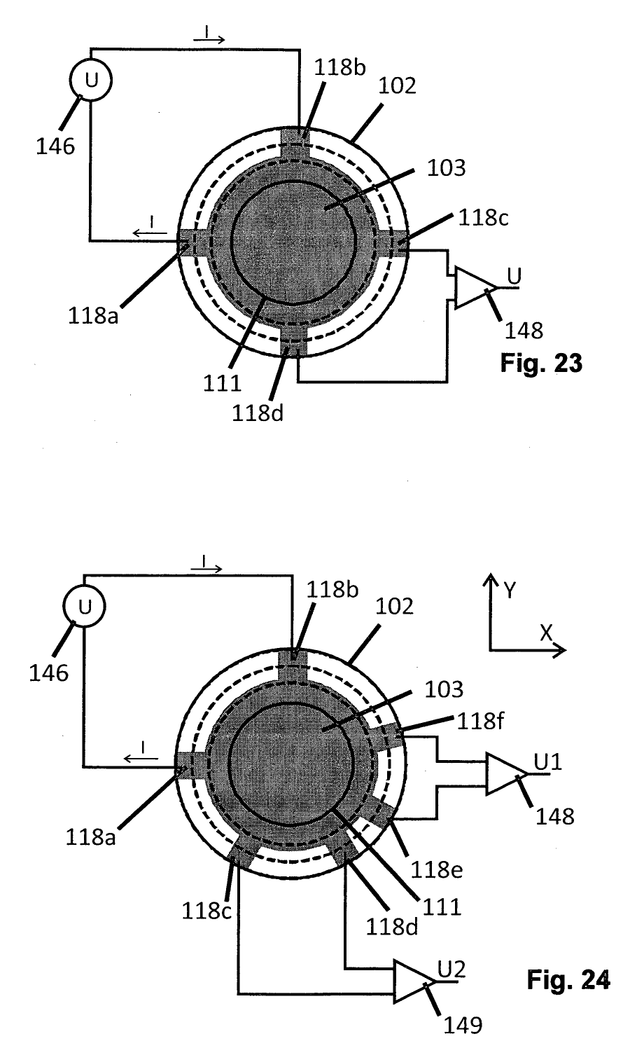

The tenth embodiment, shown in FIGS. 22, 23, has a mechanical design equivalent to the first embodiment, but differs in the layout of the sensing electrode(s). Namely, the sensing electrode consists of a single electrode 108 arranged to the top or bottom side of membrane 101. Along its circumference, it has current contact points at first and second locations 118a, 118b, and voltage contact points at third and forth locations 118c, 118d. A current or voltage source 146, in particular a constant voltage source generating a constant voltage, is connected to the first and second locations, thereby inducing a current through sensing electrode 108, which in turn generates a voltage at locations 118c, 118d. The device further comprises a voltage sensor 148 connected to the locations 118c, 118d and measuring the voltage between them.

Measurement methods of this type are known as “van der Pauw” methods and are widely to measure Hall coefficients. As can be shown, when the resistance distribution within electrode 108 changes in response to a displacement of handle 103, the voltage over the locations 118c, 118d changes as well.

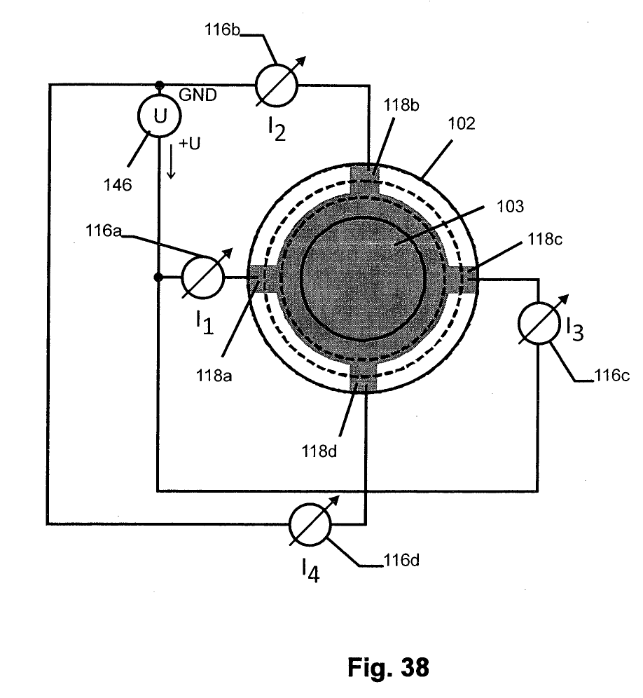

An alternative implementation of the tenth embodiment is shown in FIG. 38. As in FIGS. 22, 23, only a single sensing electrode 108 is arranged on the top or bottom side of membrane 101. Along its circumference, the sensing electrode 108 has four voltage contact points at locations 118a, 118b, 118c, and 118d. The locations 118a, 118b, 118c and 118d are advantageously located at equal angular intervals, with each voltage contact point being connected through sensing electrode 108 to all other voltage contact points. Two opposing voltage contact points at locations 118a and 118c are connected to first terminal of a voltage source 146, whereas the other two opposing voltage contact points at locations 118b and 118d are connected to a second terminal of voltage source 146. By measuring the currents I₁, I₂, I₃, and I₄ flowing through the voltage contact points at locations 118a, 118b, 118c, and 118d, e.g., by current meters 116a, 116b, 116c, and 116d, the position of the handle can be computed.

One advantage of this method is, similar to the ninth embodiment, that any environmental or aging effects proportionally affecting the resistance of electrode 108 do not vary the output signal if a constant voltage source is used.

Another advantage of this method is the fact that electrode 108 does not have to be structured.

### Eleventh Embodiment

The device according to the tenth embodiment measures a single value only, i.e. it is suited for measuring a one-dimensional displacement of handle 103. In order to measure a two-dimensional displacement, a design as shown in FIG. 24 can be used. Here, two voltage sensors 148, 149 are provided, and they are connected to two “third locations” 118c, 118e as well as two “fourth locations” 118d, 118f of electrode 108.

As can be shown, the voltages U1, U2 measured by the voltage sensors 148, 149 depend differently on the coordinates x, y of handle 103 in the X-Y-plane and it is possible to determine these coordinates x, y from the voltages U1, U2. As suitable relation can either be derived theoretically, e.g. from simulation calculations, or experimentally, using calibration measurements.

### Twelfth Embodiment

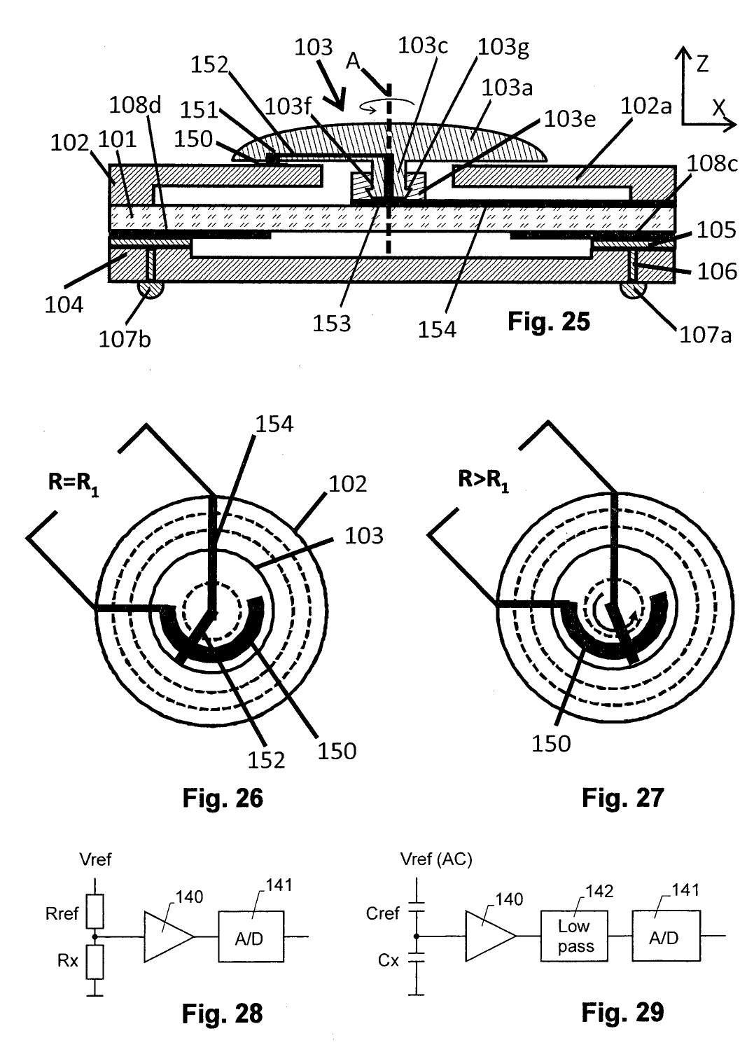

The embodiment of FIGS. 25-27 substantially shows two further possible features of the device:
a rotational connection of handle 103 to membrane 101 and, optionally,
means for measuring the rotation of handle 103.

In order to form a rotational connection of handle 103 and membrane 101, handle 103 comprises a first handle member formed by head section 103a and shaft section 103c as well as a second handle member 103e. Second handle member 103e is connected to membrane 101 e.g. by gluing or welding. Shaft section 103c of first handle member 103a, 103c extends into a central opening 103f of second handle member 103e in such a manner that it can be rotated about axis A while a relative displacement along direction Z between first handle member 103a, 103c and second handle member 103e is prevented, e.g. by a snap-in connection 103g.

Providing a rotational connection between handle 103 and membrane 101 has the advantage that a rotation of head section 103a of the handle does not distort the membrane and therefore does not affect the signals measured by the sensing electrodes.

In addition, it may be desirable to measure the rotational position between first handle member 103a, 103c and frame 102. For this purpose, a potentiometer can be arranged between the first handle member 103a, 103c and frame 102, wherein the resistance of the potentiometer changes with the rotation of the first handle member 103a, 103c.

In the embodiment of FIGS. 25-27, the potentiometer is formed by an accurate resistance strip 150 mounted to the top side of lid 102a and a sliding contact 151 in contact with resistance strip 150 and mounted to the bottom side of head section 103a. A first electric lead 152 extends through first handle member 103a, 103c to a rotational contact 153 between first handle member 103a, 103c and second handle member 103e. A second electric lead 154 is formed by an electrode on membrane 101 and leads from rotational contact 153 to a contact point at the periphery of the device.

When first handle member 103a, 103c is rotated, sliding contact 151 moves along resistance strip 150, whereby the resistance of the potentiometer is varied, which can e.g. be measured by sensing circuitry of the type shown in FIG. 28.

### Thirteenth Embodiment

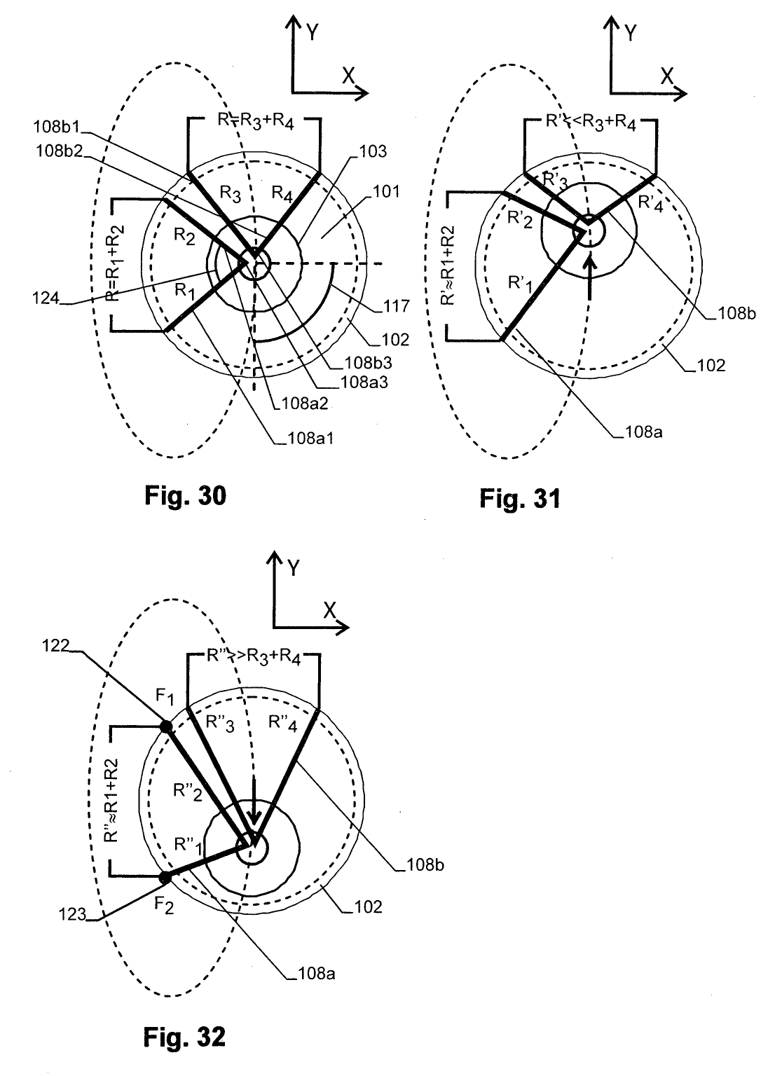

The embodiment shown in FIGS. 30 to 32 has a mechanical design similar to the first embodiment, but differs in the geometries and shapes of the sensing electrodes. Namely, each sensing electrode 108a, 108b, . . . which is arranged on or in the membrane 101 consists of two legs each, i.e., 108a1, 108a2, and 108b1, 108b2, . . . . In this example, two electrodes 108a and 108b are shown and their legs 108a1, 108a2, 108b1, and 108b2 have electrical resistance values R1, R2, and R3, R4, respectively. Furthermore, when the handle is in its central position, i.e., in its equilibrium position, said legs are advantageously basically straight, i.e. line-shaped, and they extend from a peripheral section of the membrane 101 (within the outermost 15% of the membrane radius) held by frame 102 to the central section of the membrane 101 (within the innermost 15% of the radius of the membrane) where one leg of one electrode is connected to the other leg of the same electrode in a leg connection area 108a3 or 108b3, respectively. When the handle is in its central position, i.e. in its equilibrium position, the legs of a letter V-shaped electrode 108a, 108b have substantially the same lengths. Thus, letter V-shaped electrodes 108a, 108b with an angle 124 are formed by the legs. At least two of these letter V-shaped electrodes are advantageously arranged on or in the membrane, advantageously perpendicular to each other, i.e., at a mutual angle of rotation 117 of 90° around an axis perpendicular to the membrane surface (axis A). Thus, decoupled lateral displacements of the handle in X- and Y-directions can be sensed by the electrodes with low computational effort. For illustration of this decoupling of the position readout signals, the two end points of the legs 108a1 and 108a2 in the peripheral section of the membrane 101 can be interpreted as two focal points F₁ 122 and F₂ 123 of an ellipse (cf. dashed ellipse in FIGS. 30-32) which runs through the center part of the membrane 101. Now, if the handle is deflected in a direction which corresponds to the symmetry axis one of these letter V-shaped electrodes (along the Y direction in FIG. 31 and opposite to the Y direction in FIG. 32), the resistance of the corresponding electrode changes considerably (for electrode 108b, R′=R′₃+R′₄<<R₃+R₄=R in FIG. 31 and R″=R″₃+R″₄>>R₃+R₄=R in FIG. 32) while the resistance of the perpendicular electrodes (for electrode 108a, R′=R′₁+R′₂≈R₁+R₂=R in FIG. 31 and R″=R″₁+R″₂≈R₁+R₂=R in FIG. 32) remains essentially constant (change less than ±10%). This is due to the fact that the resistances of the electrode legs are primarily dependent on their lengths and that the sum of the distances from any point on the ellipse to said two focal points is constant. Therefore, by engineering the input device and the letter V-shaped electrodes 108a and 108b such that the focal points of their corresponding ellipses lie sufficiently far apart (>30% of the diameter of the membrane 101), a quasi-orthogonal system can be created, which facilitates readout of the handle position.

Angle 124 between the legs of each letter V-shaped electrode is advantageously between 60° and 120°, in particular substantially equal to 90°. If the angle is much smaller than 90°, the ellipse (shown in dashed lines) becomes shorter and therefore a displacement of the handle 103 in a direction perpendicular to the symmetry axis of the V-shaped electrode quickly leaves the regime where the sum of the length of the two legs stays constant (deviation from the ellipse). If the angle is much larger than 90°, the sensitivity of the sensing electrode for measuring displacements of the handle parallel to its symmetry axis decreases.

When all sensing electrodes (108a, 108b) are arranged on the same side of membrane 101 at a mutual angle of 90°, angle 124 should be less or equal to 90° in order to optimally use the available space without the electrodes overlapping each other.

Optionally, a third letter V-shaped electrode 108c consisting of legs 108c1 and 108c2 which are connected in a leg connection area 108c3 can be advantageously arranged on or in the membrane 101 to enable the sensing of rotations of the handle 103 around an axis perpendicular to the membrane surface, as in this case the resistance values of all three electrodes increase by the same amount, whereas a displacement of the handle in the XY-plane never causes an increase of resistance in more than two letter V-shaped electrodes at angles of rotation 117 of 90°.

### Fourteenth Embodiment

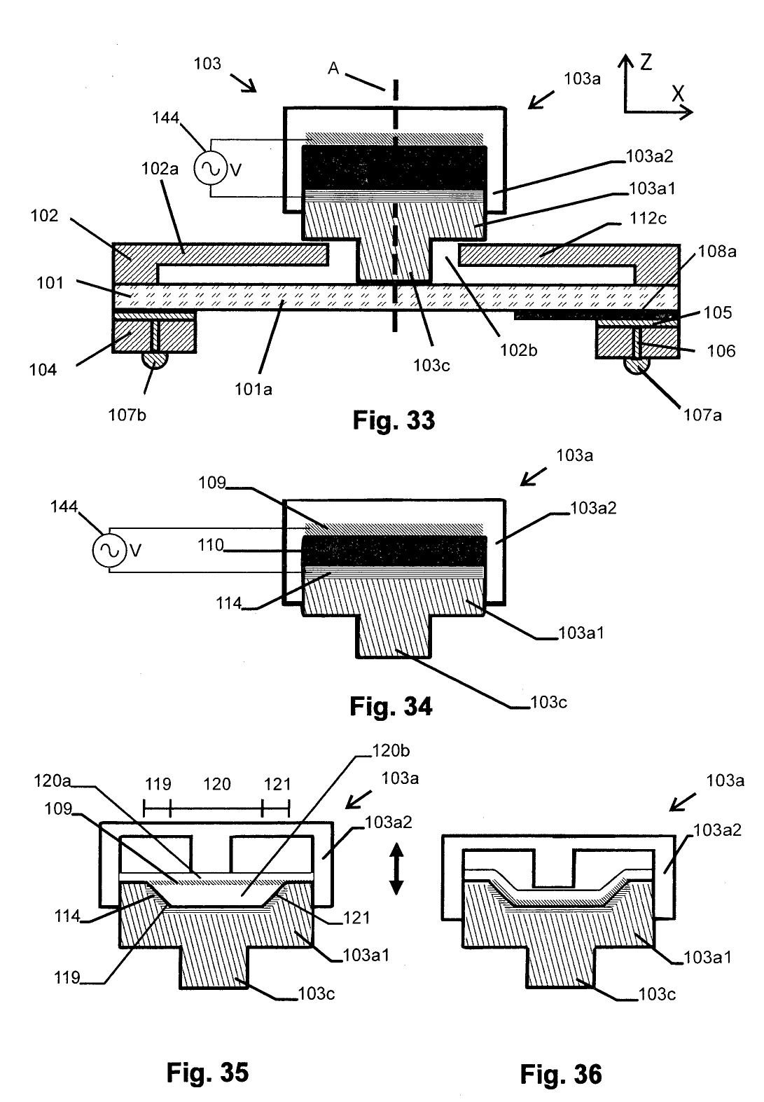

The embodiment shown in FIGS. 33 to 36 has a mechanical design similar to the first embodiment, but it differs in the design of the head section 103a of the handle 103 which consists of at least two parts 103a1 and 103a2 that can be moved axially with respect to each other, i.e., along the Z-direction by means of an actuator.

An electroactive polymer (EAP) 110 with two or more actuating electrodes 109 and 114 is arranged between and mechanically connected to the parts 103a1 and 103a2 that constitute the head section 103a of the handle 103.

The layer of electroactive polymer can be arranged similar to a “classical capacitor” actuator in which the layer of EAP is sandwiched between a top- and a bottom or a first and a second actuating electrode 109 and 114 as it is shown in FIGS. 33 and 34. In this embodiment, the application of a voltage between the actuating electrodes 109 and 114 changes the thickness of the EAP layer 110 and therefore moves part 103a2 with respect to part 103a1, thereby giving rise to a motion that can be sensed by the user.

In another embodiment, the actuator for mutually moving the parts 103a1 and 103a2 can be a zipper actuator. In this case, a flexible actuator membrane 120a spans a recess 120b with inclined edge regions 119 and 121, such that the depth of the recess gradually tapers to zero at its periphery. In the embodiment of FIGS. 35 and 36, actuator membrane 120a is connected at its periphery to first part 103a1 and at its center to second part 103a2, while recess 120b is formed in first part 103a1. However, the opposite design can be used as well, i.e., a design where recess 120b is formed in second part 103a2, etc.

A first, elastic actuating electrode 109 is connected to actuator membrane 120a, while a second actuating electrode 114 is connected to the walls and bottom of recess 120b. In such a zipper actuator, the distance between the actuating electrodes (109, 114) in the unactuated case varies as a function of location in the regions 119 and 121, e.g., in the most lateral part of region 121, the distance between the top actuating electrode 109 and the bottom actuating electrode 114 is smaller than in the most central part of region 121.

Furthermore, the device of FIGS. 33-36 comprises an AC and/or DC voltage generator 144 connected to said actuating electrodes 109 and 114 in order to apply a voltage across them (not shown in FIGS. 35 and 36). The effect of such an actuating voltage is illustrated in FIGS. 33, 34, and 35, 36, respectively. When no voltage is applied, as it is shown in FIGS. 33 and 35, the head section 103a of the handle 103 remains extended along the Z-direction. When a non-zero voltage is applied between bottom actuating electrode 114 and top actuating electrode 109, as it is shown in FIG. 34, the EAP layer 110 between the electrodes is compressed, and thereby the top part 103a2 of the head section 103a of the handle 103 is moved towards the bottom part 103a1. When a non-zero voltage is applied between bottom actuating electrode 114 and top actuating electrode 109 of the zipper actuator as it is shown in FIG. 36, starting from the lateral parts of regions 119 and 121 the top actuating electrode 109 is gradually pulled towards the bottom electrode by electrostatic forces, thus moving the top part 103a2 of the head section 103a of the handle 103 towards the bottom part'103a1.

Hence, the application of an AC voltage to the actuating electrodes causes the head section 103a of the handle 103 to vibrate. Voltage generator 144 can generate a continuously varying voltage, individual voltage pulses or any other voltage shape including DC voltage.

The advantage of a zipper actuator is that a smoother actuation can be achieved and smaller voltage levels (down to 20 V for an EAP-layer-thickness of 15 micrometers) are sufficient for actuation. The zipper actuator can also be built using membrane 101 and an electrode attached thereto.

In principle, a similar arrangement consisting of an EAP 110 with two interconnected electrodes 109 and 114 in the head section 103a of the handle 103 can also be used to detect operator induced forces on the head section 103a of the handle 103 along the Z-direction, e.g., by measuring the capacitance between top electrode 109 and bottom electrode 114.

### Fifteenth Embodiment

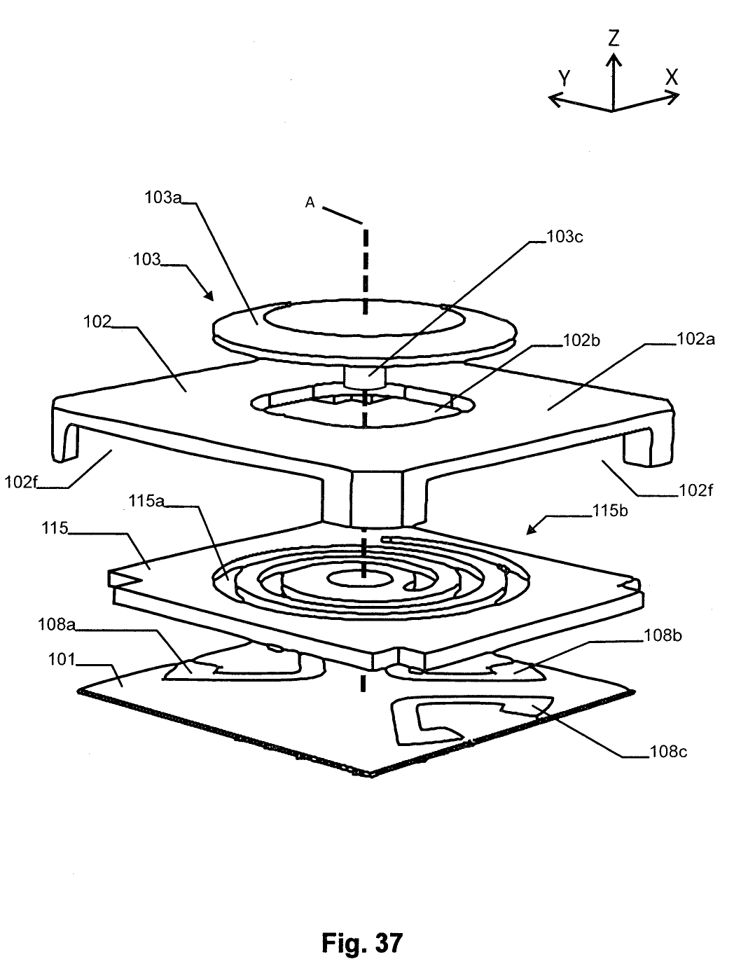

The embodiment shown in FIG. 37 has a mechanical design similar to the first embodiment with the difference that an additional spring element 115 is arranged between the shaft section 103c of handle 103 and the membrane 101. In this embodiment, the shaft section 103c of handle 103 extends from the head section 103a through the central opening 102b in the upper lid 102a of frame 102. Shaft section 103c is connected to spring element 115, which, in the shown embodiment, has the form of a spiral lying in a plane parallel to membrane 101. The center of spring element 115 and/or shaft section 103c is attached to the center of membrane 101, e.g. by welding or gluing. The spring element 115 typically consists of a thin block of metal or plastic material which advantageously has a spiral pattern 115a of material removed from the block. Thus, a spiral spring pattern 115b is formed. The resetting force of the polymer membrane 101 which drives the handle 103 back towards its “zero-position” after it is displaced is augmented by the forces from the spring element 115. In other words, the self-centering properties of the handle 103 are more pronounced in comparison to solely utilizing the resetting force of the polymer membrane 101 alone. In addition to supplementing the restoring force, the spring element can additionally aid in hampering unwanted rotational movements of the head section 103a of the handle 103 and the connected membrane 101 around an axis which is perpendicular to the surface of the polymer membrane, e.g., around axis A. By cutting out regions 102f on the lateral sides of frame 102, the frame 102 can act as spring member, which together with the spring element 115 counteracts displacements of handle 103 along the third direction Z. This can be used to implement a “click-feature” as discussed in the fifth embodiment.

While, in the embodiment of FIG. 37, spring element 115 comprises an elastic spiral, spring element 115 may alternatively, e.g., comprise elastic beams extending substantially tangentially with respect to axis A and allowing for radial, but not rotational movements of handle 103a. Hence, in more general terms, spring element 115 is an elastic element connected to the frame and generating an elastic restoring force for translational displacements of said handle parallel to said membrane and for rotational displacements of said handle about an axis A perpendicular to said membrane, wherein for a given small distance of translation of the handle the corresponding change of elastic force generated by said spring element 115 is much smaller (in particular at least five times smaller) than for a small rotational movement of the periphery of the handle about axis A by the same distance.

Materials and manufacturing:

The electrodes 108, 108a, 108b, . . . , 111 on polymer membrane 101 should be compliant, i.e. they should be able to follow the deformations of polymer membrane 101 without being damaged. Advantageously, the electrodes are therefore manufactured from one of the following materials:
Carbon nanotubes (see “Self-clearable carbon nanotube electrodes for improved performance of dielectric elastomer actuators”, Proc. SPIE, Vol. 6927, 69270P (2008);)
Carbon black (see “Low voltage, highly tunable diffraction grating based on dielectric elastomer actuators”, Proc. SPIE, Vol. 6524, 65241N (2007);)
Carbon grease/conducting greases
Metal ions (Au, Cu, Cr, . . . ) (see “Mechanical properties of electroactive polymer micro actuators with ion-implanted electrodes”, Proc. SPIE, Vol. 6524, 652410 (2007);)
Liquid metals (e.g. Galinstan)
Metal flackes
Metallic powders, in particular metallic nanoparticles (Gold, silver, copper)
Conducting polymers (intrinsically conducting or composites)

The electrodes may be deposited by means of any of the following techniques:
Spraying
Ion-implantation (see “Mechanical properties of electroactive polymer micro actuators with ion-implanted electrodes”, Proc. SPIE, Vol. 6524, 652410 (2007);)
PVD, CVD
Evaporation
Sputtering
Photolithography
Printing, in particular contact printing, inkjet printing, laser printing, and screen printing.
Field-guided self-assembly (see e.g. “Local surface charges direct the deposition of carbon nanotubes and fullerenes into nanoscale patterns”, L. Seemann, A. Stemmer, and N. Naujoks, Nano Letters 7, 10, 3007-3012, 2007)
Brushing
Electrode plating

The material for the slider button can e.g. comprise or consist of:
PMMA
Glass
Plastic
Polymer
Metal
Silicon

The material for polymer membrane 101 can e.g. comprise or consist of:
Gels (Optical Gel OG-1001 by Liteway),
Elastomers (TPE, LCE, Silicones e.g. PDMS Sylgard 186, Acrylics, Urethanes)
Thermoplast (ABS, PA, PC, PMMA, PET, PE, PP, PS, PVC, . . . )
Duroplast

As described above, an advantageous method for manufacturing the device can comprise the steps of:
Manufacturing or providing a polymer film of any of the materials mentioned above.
Applying the electrode(s) to the polymer film, using any of the techniques above.
Stretching the polymer film and electrodes, advantageously by at least 20%, e.g. 100%, in x- and y-direction, thereby forming the membrane.
Attaching the membrane to frame 103, e.g. using welding, bonding, tapes or gluing techniques.
Applying handle 103 to membrane 101.

Advantageously, a plurality of devices of this type can be manufactured in parallel, using a single polymer film and cutting the same after applying it to the frames.

Some applications:

The device shown above can be used for detecting a displacement of handle 103 along first direction X. Optionally, and as shown, it can also be used for detecting any of the following:
a displacement of handle 103 along second direction Y,
a displacement of handle 103 along third direction Z,
a rotation of handle 103 about its vertical axis.

The device can be used in a large variety of applications, such as:
Input device with active feedback for gaming in hand-held devices
Joystick for motion control
Input device for gaming units
Input device for machine control
Input device for dimmer control

Notes:

The different aspects of the various embodiments shown above can be combined in arbitrary manner. For example, even though only the second embodiment is shown to use capacitive sensing, capacitive sensing can be used with any of the other embodiments as well.

As mentioned, handle 103 can be displaced, parallel to membrane 101, in a single direction only or in two directions. Advantageously, when a displacement in two directions is to be monitored, at least one first sensing electrode deformed upon displacement of handle 103 into first direction X is provided, and at least one second sensing electrode deformed upon displacement of handle 103 into second direction Y. Alternatively, a single sensing electrode can be used as shown in the embodiment of FIG. 24.

Since the three functions, namely displacement sensing, selection and active feedback can be integrated in one electrode coated polymer membrane, the device is of small size and low cost. Furthermore, the potentially soft materials guarantee a long life and high mechanical shock stability.

The various electrodes can have a single function only (e.g. as a sensing electrode, a contact electrode or an actuating electrode as described above), or they can combine several functions. For example, a single electrode can be used as sensing electrode and actuating electrode, e.g. in a time-shared manner, or as an actuating electrode and a contact electrode. The electrodes can be single or multilayered.

The deformation of the film polymer depends on the material properties such as elastic modulus of the material used, the shape of the material, as well as the boundary conditions.

The shape of the frame, handle as well as of the polymer membrane and the electrodes can be adapted to the various applications. In particular, the electrodes, the film, the frame as well as the handle can be of any suitable shape and e.g. be triangular, rectangular, circular, linear or polygonal. The sensing electrodes can also have annulus shape.

The invention is not limited to the shapes of the polymer membrane as described above. Indeed, other shapes could be defined for achieving mechanical displacement sensing, selection functionality and active mechanical feedback.

In the embodiments described above, the compliant electrodes are arranged on a surface of the membrane. Alternatively, the electrodes can be embedded within the membrane, i.e. if the membrane is made from several polymer films laminated to each other with the electrodes between them.

While there are shown and described presently preferred embodiments of the invention, it is to be distinctly understood that the invention is not limited thereto but may be otherwise variously embodied and practiced within the scope of the following claims.

1. An input device comprising
a frame,
a flexible polymer membrane held in the frame,
a sensing electrode arranged on or in said membrane, wherein said sensing electrode is adapted to be reversibly and elastically extended together with the membrane by at least 20% without being damaged, and
a handle mounted to said frame and connected to said membrane, wherein said handle is displaceable at least along a first direction parallel to said membrane, wherein a displacement of said handle in said first direction causes a deformation of said sensing electrode.

2. The input device of claim 1, wherein, in the absence of an external force applied to said handle, said membrane moves said handle to a zero position, and wherein, upon application of said external force to said handle, said handle is displaced from said zero position against a resetting force of said membrane.

3. (canceled)

4. The input device of claim 1 wherein said membrane comprises a suspended section suspended within said frame, wherein said handle is connected to a part of said suspended section and wherein at least part of said sensing electrode is arranged on or in said suspended section.

5. The input device of claim 1 further comprising a resistance sensing circuit connected to said sensing electrode,
and wherein the device comprises a reference electrode arranged on said membrane, wherein said resistance sensing circuit is adapted to measure a resistance of said sensing electrode in respect to a resistance of said reference electrode.

6. The input device of claim 1 comprising at least a top and a bottom sensing electrode arranged on opposite sides of said membrane and a capacitance sensing circuit connected to said top and bottom sensing electrodes.

7. The input device of claim 1, wherein said handle is displaceable in said first direction parallel to said membrane and in a second direction parallel to said membrane and perpendicular to said first direction, wherein said input device further comprises
at least one first sensing electrode deformed upon displacement of said handle in said first direction, and
at least one second sensing electrode deformed upon displacement of said handle in said second direction

8. The input device of claim 1, wherein said handle is displaceable in a third direction perpendicular to said membrane, wherein said input device further comprises
a first contact electrode mounted to said membrane,
a second contact electrode mounted to said frame, and
a gap between said first and second contact electrodes,
wherein a sufficient displacement of said handle along said third direction deforms said membrane for expanding, narrowing or closing said gap.

9-12. (canceled)

13. The input device of claim 1, wherein said handle comprises a first handle member and a second handle member, with said first handle member being rotatable in respect to said second handle member about an axis perpendicular to said membrane, wherein said second handle member is connected to said membrane.

14. (canceled)

15. The input device of claim 1 comprising
at least a top and a bottom actuating electrode arranged on opposite sides of said membrane and
a voltage generator for applying an AC and/or a DC voltage across said top and bottom electrodes.

16. (canceled)

17. The input device of claim 1 comprising
a first electrode section and a second electrode section arranged at different regions on or in said membrane,
a sensing circuit adapted to measure a parameter depending on a ratio of the resistances of said first and said second electrode sections.

18. (canceled)

19. The input device of claim 1 wherein said sensing electrode comprises at least two legs that extend from a peripheral section of said membrane to a central section of said membrane, and
wherein said legs are connected to each other in a leg connection area in said central section of said membrane.

20. The input device of claim 19 wherein said legs have the same length,
wherein said legs are straight lines, and
wherein an angle between said legs is greater than 45° and smaller than 120°.

21. The input device claim 19 wherein at least two of said electrodes are arranged on or in said membrane at a mutual rotation angle with an axis of rotation perpendicular to said membrane.

22. (canceled)

23. The input device of claim 1 comprising a spring element connected to said frame and generating an elastic restoring force for translational displacements of said handle parallel to said membrane and for rotational displacements of said handle about an axis perpendicular to said membrane, wherein for a given distance of translation of the handle a corresponding change of elastic force generated by said spring element is smaller than for a rotational movement of a periphery of the handle by the same distance about an axis perpendicular to said membrane.

24. The input device of claim 1 comprising an actuator for moving said handle.

25. The input device of claim 24 wherein said actuator comprises a zipper actuator comprising
a flexible actuator membrane spanning a recess, wherein a depth of said recess tapers to zero at a periphery of said recess,
at least a first actuating electrode connected to said actuator membrane, and
at least a second actuating electrode connected to a bottom and side walls of said recess.

26. The input device of claim 24 wherein a head section of the handle comprises a first part and a second part and said actuator for moving said first part with respect to said second part.

27-28. (canceled)

29. A method for manufacturing the input device of claim 1 comprising the steps of
applying at least one electrode to a polymer film
stretching the polymer film by at least 20%, in at least said first direction, thereby forming said membrane,
attaching the membrane to said frame, and
applying said handle to the membrane.

30. (canceled)

31. The input device of claim 23 wherein said spring element comprises a spiral lying in a plane parallel to said membrane.

32. The input device of claim 24 wherein said actuator comprises
at least one layer of electroactive polymer
at least a first actuating electrode connected to a first side of said electroactive polymer, and at least a second actuating electrode connected to a second side of said electroactive polymer.
